(19) United States
(12) Patent Application Publication
(10) Pub. No.: US 2022/0398486 A1
(43) Pub. Date: Dec. 15, 2022

(54) LEARNING CONTENT RECOMMENDATION SYSTEM BASED ON ARTIFICIAL INTELLIGENCE LEARNING AND OPERATING METHOD THEREOF

(71) Applicant: RIIID INC., Seoul (KR)

(72) Inventors: Young Nam LEE, Seoul (KR); Young Duck CHOI, Seoul (KR); Jung Hyun CHO, Seoul (KR); Hyun Bin LOH, Seoul (KR); Chan You HWANG, Seoul (KR); Young Ku LEE, Seoul (KR)

(21) Appl. No.: 17/343,735

(22) Filed: Jun. 10, 2021

(30) Foreign Application Priority Data
Jun. 9, 2020 (KR) 10-2020-0069409

(51) Int. Cl. G06N 20/00; G06N 5/04

(52) U.S. Cl. CPC G06N 20/00; G06N 5/04

(57) ABSTRACT

The present invention is to predict a correct answer probability of a user for a specific question with higher accuracy, and provide learning content having more increased efficiency. A method for operating a learning content recommendation system includes transmitting question information including information on a plurality of questions to a user, receiving solving result information that is the user's response for the plurality of questions, and training a user characteristic model based on the question information and the solving result information, wherein the training of the user characteristic model includes assigning a weight to the user characteristic model based on a degree of influence on a correct answer probability in a sequence of questions input to the user characteristic model.

### CROSS-REFERENCE TO RELATED APPLICATION

This application claims priority from Korean Patent Application No. 10-2020-0069409 filed on Jun. 9, 2020 in the Korean Intellectual Property Office, the disclosure of which is incorporated herein by reference in its entirety.

### BACKGROUND OF THE INVENTION

### 1. Field of the Invention

The present invention relates to a learning content recommendation system that learns a user characteristic model using an artificial intelligence model and provides customized learning content based on the learned user characteristic model, and an operating method thereof.

### 2. Description of the Related Art

Recently, deep learning, which is a representative technique of the 4th generation artificial intelligence (AI) and a field of machine learning, is emerging. In this deep learning, inference of predictive data is performed using a neural network that is a single network such as a convolutional neural network (CNN), a recurrent neural network (RNN), and a long short term memory (LSTM) neural network. In particular, in the case of RNN, the artificial neural network is learned using various types of information, and then data prediction is performed using results of learning. However, there is a problem that data prediction is not performed properly because the information learned a long time ago is lost. In order to solve these shortcomings of RNN, LSTM neural networks have begun to be used.

LSTM has feedback connections and may process not only single data but also entire data sequences. Since LSTM also receives processed values of previously input data when processing the most recently input data, LSTM is suitable for processing long-term memory of sequence data. In LSTM, processed values of all input data are re-referenced whenever an output result is predicted, and data related to the output result is focused (attention, weight). Through such a learning process, the artificial neural network may be learned to adjust weights between nodes of the artificial neural network and obtain a desired inference result.

Conventionally, various types of artificial intelligence models such as CNN, RNN, and LSTM described above have been used to obtain desired inference values in various fields. However, since learning questions that can be provided to users and the number of users' responses to the questions are limited, there is a problem that there is a lack of detailed research on what is the optimal artificial intelligence model and how to configure the input data format to predict with higher accuracy in the field of education, where efficient modeling of interactions between learning content and users by maximizing data sequence efficiency of pairs of learning questions and user responses is significant.

### SUMMARY OF THE INVENTION

In order to solve the above-described problem, a learning content recommendation method according to an embodiment of the present invention employs an artificial intelligence model with a bidirectional LSTM architecture having an weighting (attention) concept in the field of education and trains an artificial neural network by assigning weights in forward sequences and backward sequences according to influence on prediction of a correct answer probability based on questions solved by a user and responses to the questions to predict the correct answer probability of the user for a specific question with higher accuracy.

In addition, the learning content recommendation method according to an embodiment of the present invention may define a user's state only with the questions solved by the user and/or the user's question solving results in order to solve a problem that it is difficult to dynamically update the user's state.

In addition, the learning content recommendation method according to an embodiment of the present invention has an effect of increasing learning efficiency by introducing a review question recommendation method using attention in an educational field where it is difficult and expensive to create new learning content.

An operating method for a learning content recommendation system is to predict a correct answer probability of a user for a specific question with higher accuracy and provide learning content having more increased efficiency, and includes transmitting question information including information on a plurality of questions to a user, receiving solving result information of the user's response for the plurality of questions, and training a user characteristic model based on the question information and the solving result information, wherein the training of the user characteristic model includes assigning a weight to the user characteristic model based on a degree of influence on a correct answer probability in a sequence of questions input to the user characteristic model.

According to an embodiment of the present invention, a learning content recommendation system includes a learning information storage unit configured to store question information of a plurality of questions, solving result information of a user's response for the plurality of questions, or learning content, and a user characteristic model training unit configured to train a user characteristics model based on the question information and the solving result information, wherein the user characteristic model training unit assigns a weight to the user characteristics model based on a degree of influence on a correct answer probability in a sequence of questions input to the user characteristics model.

### BRIEF DESCRIPTION OF THE DRAWINGS

FIG. 1 is a diagram for describing a learning content recommendation system according to an embodiment of the present invention.

FIG. 2 is a diagram for describing in detail an operation of the learning content recommendation system of FIG. 1.

FIG. 3 is a diagram for describing an operation of determining a question to be recommended by calculating question information.

FIG. 4 is a diagram for describing correlation between a weighted solving result information and a tag matching ratio according to an embodiment of the present invention.

FIG. 5 is a flowchart for describing an operation of a learning content recommendation system according to an embodiment of the present invention.

FIG. 6 is a view for describing in detail step S505 of FIG. 5.

### DESCRIPTION OF THE EXEMPLARY EMBODIMENTS

Specific structural or step-by-step descriptions of embodiments according to the concept of the present invention disclosed in this specification or application are exemplified only for the purpose of describing the embodiments according to the concept of the present invention, and embodiments according to the concept of the present invention may be implemented in various forms and should not be construed as being limited to the embodiments described in the present specification or application.

Since the embodiments according to the concept of the present invention can be modified in various ways and have various forms, specific embodiments will be illustrated in the drawings and described in detail in the present specification or application. However, this is not intended to limit the embodiments according to the concept of the present invention to a specific form of disclosure, and it should be understood to include all changes, equivalents, or substitutes included in the spirit and scope of the present invention.

Terms such as first and/or second may be used to describe various elements, but the elements should not be limited by the terms. The above terms are only for the purpose of distinguishing one component from other components, and a first component may be referred to as a second component, and similarly a second component may also be referred to as a first component, for example, without departing from the scope of claims according to the concept of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other expressions describing the relationship between components, such as “between” and “just between” or “adjacent to” and “directly adjacent to” should be interpreted in the same manner.

Terms used in the disclosure are used to describe specific embodiments and are not intended to limit the scope of the present invention. As used herein, singular forms may include plural forms as well unless the context clearly indicates otherwise. It will be further understood that the terms “comprises,” “comprising,” “have,” “having,” “includes,” “including” and/or variations thereof, when used in this specification, specify the presence of stated features, numbers, steps, operations, elements, and/or components, but do not preclude the presence or addition of one or more other features, numbers, steps, operations, elements, components, and/or groups thereof.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined in the present application.

In describing the embodiments, descriptions of technical contents that are well known in the technical field to which the present invention pertains and are not directly related to the present invention will be omitted. This is to more clearly convey the gist of the present invention by omitting unnecessary description.

Hereinafter, the present invention is described by describing preferred embodiments in detail with reference to the accompanying drawings. Hereinafter, embodiments of the inventive concept will be described in detail with reference to the exemplary drawings.

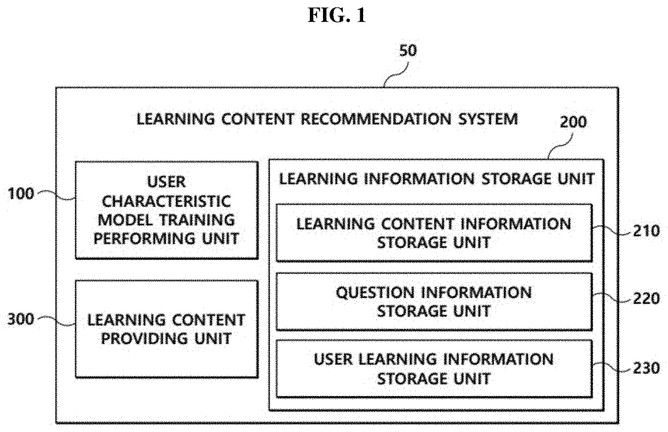

FIG. 1 is a diagram for describing a learning content recommendation system according to an embodiment of the present invention.

Referring to FIG. 1, a learning content recommendation system 50 may include a user characteristic model training performing unit 100, a learning information storage unit 200, and a learning content providing unit 300.

The learning content recommendation system 50 according to an embodiment of the present invention may provide a question to a user and receive solving result information of the user. The question information and the solving result information for the corresponding question may be matched and stored in a user information storage unit 230 of the learning information storage unit 200.

Conventional platforms for providing learning content have used collaborative filtering to analyze relationships between users and learning questions. Collaborative filtering is a technology that inputs all usage history and consumption history of platform users and filters unnecessary information based on the use and consumption records.

In collaborative filtering, a user characteristic model is trained based on results of solving all questions of a specific user, and the user characteristic model is re-trained whenever a new question or user's solving result information is added. However, the method using this collaborative filtering has a problem that it is not suitable for real-time user characteristic modeling because the model needs to be re-trained whenever new information is added.

In addition, in order to train an artificial intelligence model to have optimum accuracy, a question information and a user's solving result information for the question information are required as much as possible. The collaborative filtering is made under assumption that users with the same disposition or characteristics will make similar choices based on individual user learning information previously collected. Therefore, there is a problem that learning content cannot be properly recommended in the initial period when user learning information of the corresponding user is insufficient.

Compared to the increasing number of users, questions provided to users are bound to be limited. Therefore, training a user characteristic model through a limited number of questions and a user's responses to the questions is an issue to be solved in order to analyze individual characteristics of a user. The user learning information may include user's solving result information for a specific question, an expected score of the user, information on a vulnerable question type, information on learning content having an optimal learning efficiency for a specific user, and the like.

The learning content recommendation system 50 may train a user characteristic model based on a large amount of user learning information of other users who have already learned, unlike the collaborative filtering in which recommendation of learning content is possible only when all the user's individual user learning information is known, and, through this, provide optimized learning content to newly introduced users only by solving the minimum diagnosis questions.

Specifically, since the learning content recommendation system 50 according to an embodiment of the present invention can generate a user vector with vectors of questions solved by a user, it is possible to create user vectors for individual's user learning information in real time even without previously learned user vectors. On the other hand, since the collaborative filtering requires each user's user vector in advance to predict a correct answer probability, there is an inefficiency of performing new learning to generate a user vector whenever a new user is introduced.

As described above, since the user modeling according to the embodiment of the present invention defines the user's state only with the questions solved by the user and/or the user's question solving results, it is possible to solve a problem that it is difficult to dynamically update the user's state. Various methods can be used for such user modeling. According to an embodiment, it can be generated by performing inner product on a question vector representing a question solved by the user at a specific point in time (or a question vector expressed in the sequence of question solving) and a question solving result vector representing a solving result of the question, or by performing inner product on a weight adjusted to more accurately reflect the user's correct answer probability and the question vector. This is only an example, and a method for generating a user vector using only the question solving result may vary according to embodiments.

Unlike the collaborative filtering, the learning content recommendation system 50 according to an embodiment of the present invention may employ a time index to express user characteristics. For example, the learning content recommendation system 50 may generate a question and a user model by applying a bidirectional LSTM-based artificial intelligence model which has been used in the conventional natural language processing field to an education domain.

Specifically, the learning content recommendation system 50 according to an embodiment of the present invention may generate a user vector by embedding a question solving sequence of a corresponding user, and train an LSTM-based artificial intelligence model in the forward and backward directions to provide the most efficient learning content to a new user with only a small amount of data without the need to newly train a user characteristic model every time the new user is introduced.

In the AI model of the bidirectional LSTM architecture, it is possible to analyze whether a specific question is answered correctly or incorrectly by being correlated with the question solving result after question solving by training the AI model in the sequence in which the user solves a current question in a forward sequence and training the AI model in the backward sequence in the reverse sequence of the user's question solving sequence.

For example, when the user has incorrectly answered question no. 5 in the past, it may be interpreted that the reason why the user incorrectly answered question no. 10 currently has association with the reason why the user incorrectly answered question no. 5 which has a similar type with question no. 10. On the other hand, when the user has incorrectly answered question no. 5 in the past, it may be interpreted that the reason why the user incorrectly answered question no. 5 in the past has association with the reason why the user incorrectly answered question no. 10 currently.

In the field of education, the sequence of questions starting from question no. 1 was decided at random by a questioner, and in order to accurately identify the user's learning level and provide content with optimal learning efficiency, it is necessary to comprehensively analyze the user's solving results for all questions.

Since the artificial neural network model with the bidirectional LSTM architecture can analyze the questions solved by the user in the past based on question solving results which a user has currently solved, it is possible to more efficiently figure out the user's learning level in an education domain environment with a limited number of questions.

Using the artificial neural network model with the bidirectional LSTM architecture, it is possible to maximize learning efficiency with only limited learning content in the field of education in which it is difficult and expensive to create new learning content. In particular, since the learning content recommendation system 50 according to an embodiment of the present invention determines review questions with higher accuracy by weighting question information according to the degree of influence on the prediction of the correct answer probability by introducing the attention concept.

Furthermore, since it is possible to analyze whether or not a specific question is correctly or incorrectly answered by associating with question solving results after question solving, it is possible to more accurately figure out types of questions which users are often wrong or vulnerable with only limited learning content and recommend review questions which the user needs to study again. Questions that have a high influence on predicting the correct answer probability include questions (or question types) which a user incorrectly answered frequently, questions which have the same type but are irregularly answered correctly by a user, and questions (or question types) which a user hardly incorrectly answers.

The user characteristic model training performing unit 100 may train a user characteristic model based on a series of information obtained by matching a plurality of question information provided to a plurality of users with a plurality of solving result information to the question information. Training of the user characteristic model may be an operation of assigning weight to question information according to a degree of influence on prediction of the probability of a correct answer.

For example, a type of questions which the user has often incorrectly answered may be an important type of question that reduces the user's total score. Such question type is assigned a high weight, and it can be predicted that the correct answer probability of a user is low for a new question having a similar question type.

In an embodiment, a question type which the user hardly answers incorrectly may be another important type of question that increases the user's total score. According to embodiments, such a question may be assigned a high weight, and it may be predicted that the correct answer probability of the user is high for a new question having a similar question type.

In another embodiment, a high weight may be assigned to questions which have the same type but for which the user irregularly provides a correct answer. This is because the user may not have an established concept for the question type. In addition, weights may be assigned to solving result information according to various algorithms

The learning information storage unit 200 may include a learning content information storage unit 210, a question information storage unit 210, and a user learning information storage unit 230.

The learning content information storage unit 210 may store a lecture or a description for a question in various ways such as text, video, picture, and speech. When customized learning content is provided to a user based on the trained user characteristic model, the learning content information storage unit 210 may provide learning content information at a request of the learning content providing unit 300. The learning content information storage unit 210 may be periodically updated and managed according to an administrator's addition or deletion of learning content.

The question information storage unit 220 may store various types of questions to be provided to the user. The question information storage unit 220 may store questions which are predicted to be the most helpful when the user solves the questions when determining the optimal learning content based on the user characteristic model that has been trained, as well as questions provided to the user for training the user characteristic model.

The user learning information storage unit 230 may store user's solving result information for a specific question. Further, The user learning information storage unit 230 may store predicted score of a corresponding user, information on a vulnerable question type, information on learning content having the best learning efficiency, and the like, which are predicted through the user characteristic model based on the solving result information.

The user learning information may be updated by reflecting the user's changing ability whenever the user characteristic model is trained. In addition, when a new user is introduced, the solving result information of the new user may be analyzed and additionally stored in the user learning information storage unit 230.

The learning content providing unit 300 may predict a correct answer probability for a specific question of a specific user according to the training result of the user characteristic model training performing unit 100, and provide learning content having optimal efficiency based on the correct answer probability.

According to the learning content recommendation system 50 according to an embodiment of the present invention, it is possible to predict the correct answer probability of a user for a specific question with higher accuracy using only limited question information and user response information through an artificial intelligence model with a bidirectional LSTM architecture.

In addition, it is possible to provide learning content by recommending learning content based on a question (a question assigned a high weight) that has a high influence on predicting a correct answer probability, not the similarity of the vector corresponding to a question for which the user frequently provides an incorrect answer.

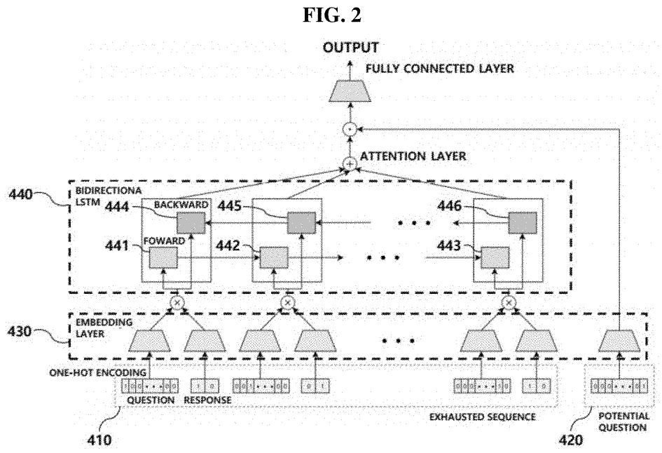

FIG. 2 is a diagram for describing in detail an operation of the learning content recommendation system of FIG. 1.

Referring to FIG. 2, training of the user characteristic model may be performed through an artificial intelligence model based on a bidirectional LSTM. In the artificial intelligence model based on the bidirectional LSTM architecture, a question solved by a user and a user's response to the question are embedded and input as learning data 410, and then used for training of the artificial intelligence model in a forward sequence and a backward sequence.

Specifically, the question and the response to the question may be matched with each other and input to the artificial intelligence model as learning data 410. The learning data 410 may be composed of a question that the user has already solved and a response to the question, which are expressed as vectors. Thereafter, when a question 420 that has not yet been solved by a user is input, the user characteristic model may predict a correct answer probability (output) through an inference process according to a weight for the corresponding question.

In this case, the question information and the solving result information may be numerically expressed through an embedding layer 430. Embedding may be an operation of writing the meaning of a word, sentence, or text while calculating the association and indicating it through numerical values, even when the expressions or forms input by the user are different.

The learning data 410 and the unsolved question 420 may be embedded in the embedding layer 430 and then input to the LSTM layer 440. The LSTM layer 440 may perform an operation of training the artificial intelligence model by reflecting different weights for each of the learning data 410 according to the degree of influence on the correct answer probability.

The learning content recommendation system 50 may perform a learning and inference process by additionally using a time index to express the characteristics of a user. Specifically, question information and solving result information may be learned in the artificial intelligence model according to the sequence (forward sequence) of questions input to the user characteristic model. Learning may be an operation of assigning different weights to each of the user's solving result information for a specific question based on a degree of influence on the correct answer probability.

In addition, the training of the artificial intelligence model may be performed in backward sequences of the sequence of questions input to the user characteristic model. In this case, the learning is not necessarily performed in the forward sequences and then in the backward sequences, but forward and backward learning may be simultaneously performed.

In FIG. 2, the weights may be adjusted while passing through a plurality of forward LSTM cells 441, 442 and 443 according to the forward sequences in which the learning data 410 is input, and may be adjusted while passing through a plurality of backward LSTM cells 444, 445 and 446 according to the backward sequences of the sequences in which the learning data 410 is input.

The sequence of questions input to the user characteristic model may be a sequence in which the user solves questions. Whenever a user solves a question, a solving result information of the question may be transferred to the user characteristic model in real time. Based on this, it is possible to predict in real time a correct answer probability to a next question to be provided to the user.

However, the sequence of the questions input to the user characteristic model may be the sequence in which the administrator inputs previously accumulated question information and solving result information in an arbitrary sequence to train artificial intelligence, and in addition, the sequence of questions input to the user characteristic model may be determined according to various algorithms.

After training is completed by reflecting the solving result information, the user characteristic model may have a fixed weight. Thereafter, when a new question, that is, a question 420 not solved by a user, is input, the user characteristic model can predict the user's correct answer probability (output) for a new question through an inference process according to weights.

Although predicting a correct answer probability of the user for a specific question based on an artificial intelligence model with a bidirectional LSTM architecture has been described, the present invention is not limited thereto, and various artificial intelligence models such as an RNN, an unidirectional LSTM, a transformer, and a CNN may be used.

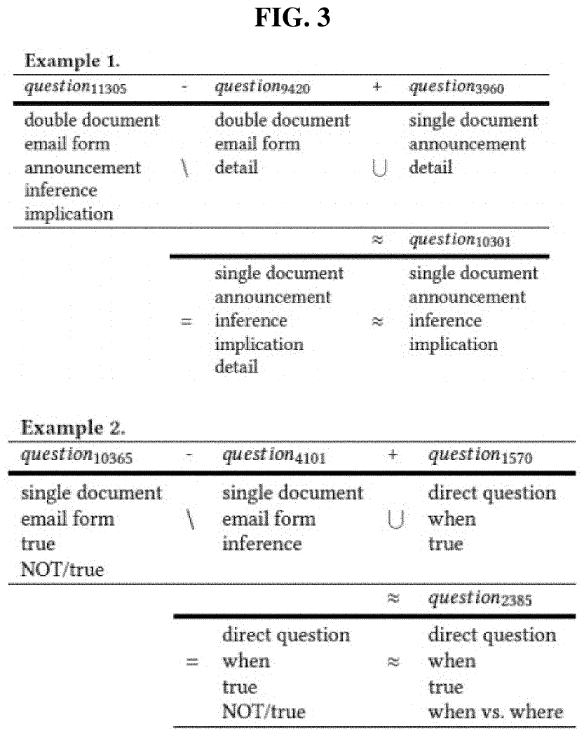

FIG. 3 is a diagram for describing an operation of interpreting question vectors using a tag matching ratio and determining a question to be recommended according to an embodiment of the present invention.

Referring to FIG. 3, Example 1 shows a process of interpreting a certain question (question10301) by combining three questions (question11305, question9420, and question3960), and Example 2 shows a process of interpreting a certain question (question2385) by combining another three questions (question10365, question4101, and question1570).

In an embodiment, each question may be stored in such a way to tag, onto a relevant question, a subject matter of the question, such as to-infinitive, article, or gerund, a type of a question, such as grammar, tense, vocabulary, or listening, key words, and a format of text, such as emails, articles, letters, or official documents.

In Example 1, question11305 includes five tags: double document, email form, announcement, inference, and implication, question9420 includes three tags: double document, email form, and detail, and question3960 includes three tags: single document, announcement, and detail.

In this case, five tags of single document, announcement, inference, implication, and detail may be extracted by subtracting the tags of question9420 from the tags of question11305 and adding the tags of question3960.

Meanwhile, question11305, question9420, and question3960 may be expressed as question vectors 11305, 9420 and 3960 through a bidirectional LSTM-based artificial intelligence model according to an embodiment of the present invention. Thereafter, calculating “question vector 11305−question vector 9420+question vector 3960” will yield a certain vector value. In this case, the tags of question10301 having a vector value with a high cosine similarity with the calculated vector value can be identified. As a result, the tags (i.e. single document, announcement, inference, and implication) of question10301 will be identified in a form similar to single document, announcement, inference, implication, and detail, which are resulted from “tags of question11305−tags of question9420+tags of question3960”. The reason for this is that the artificial intelligence model according to the embodiment of the present invention expresses a question vector to better reflect the characteristics of the question.

Using these characteristics, it is possible to interpret the characteristics of the question in a form that humans can understand using the question vector. Since interpreting the characteristics of the question and expressing the characteristics of the question with tags in a form that can be recognized by a person requires manual work by an expert, it is expensive, and the tag information depends on the subjectivity of the person, thus leading to low reliability. However, when the tag information of a question is generated by tagging the result of combining the tags of a plurality of questions onto a question having a vector value similar to a vector value resulted by combining a plurality of question vectors, the dependence of the expert is lowered and the accuracy of the tag information is raised.

Furthermore, question10301 may represent a question extracted from the above five tags (i.e. single document, announcement, inference, implication, and detail). The question information storage unit 220 stores many questions, but it may be practically impossible for a question including all combinations of numerous tags to exist. In Example 1, question10301 may be a question having the highest similarity with the five tags (i.e. single document, announcement, inference, implication, and detail). The question having the highest similarity may be determined from among questions with a tag matching ratio is greater than a preset value.

Similarly, referring to Example 2, question10365 may include four tags: single document, email form, true, and NOT/true, question4101 may include three tags: single document, email form, and inference, and question1570 may include three tags: direct question, when, and true.

In this case, by subtracting the tags of question4101 from the tags of question10365 and adding the tags of question1570; four tags of direct question, when, true, and NOT/true can be finally extracted.

Meanwhile, question10365, question4101, and question1570 may be expressed as question vectors 10365, 4101, and 1570 through a bidirectional LSTM-based artificial intelligence model according to an embodiment of the present invention. Thereafter, calculating “question vector 10365−question vector 4101+question vector 1570” will yield a certain vector value. In this case, the tags of question2385 having a vector value with a high cosine similarity with the calculated vector value can be identified. As a result, the tags (i.e. direct question, when, true, and when vs. where) of question2385 will be finally identified in the form similar to “tags of question10365−tags of question4101+tags of question1570; direct question, when, true, and NOT/true.

Furthermore, question2385 can represent a question extracted from the above four tags (i.e. direct question, when, true, and NOT/true). The question information storage unit 220 stores many questions, but it may be practically impossible for a question including all combinations of numerous tags to always exist. Question2385 may be a question having the highest similarity to the four tags (i.e. direct question, when, true, and NOT/true).

The question recommended in Examples 1 and 2 may be a question with the highest similarity to the extracted tags. In this case, a method for determining a question with the highest similarity may be performed through a method for searching for a question having the highest tag matching ratio or a method for searching for a question assigned a high weight.

First, the tag matching ratio may be a value obtained by dividing an intersection of tags included in a question already solved by a user and tags included in a question to be provided next by the number of tags included in the question to be provided next. As a question has a higher tag matching ratio, tags included in questions correctly answered by the user are more effectively removed, and tags included in questions incorrectly answered by the user are reflected more accurately.

In addition, tags included in each question can be used not only to calculate the tag matching ratio, but also to determine weights to be assigned to the artificial intelligence model. The user's solving result information may be interpreted as a correct answer probability of a user for a specific question or for each tag.

When weights are assigned to the user characteristic model, different weights can be assigned to tags included in each question, and through this, it is possible to determine a recommendation question through a method for searching for questions including a large number of specific tags assigned a high weight, that is, having a low correct answer probability.

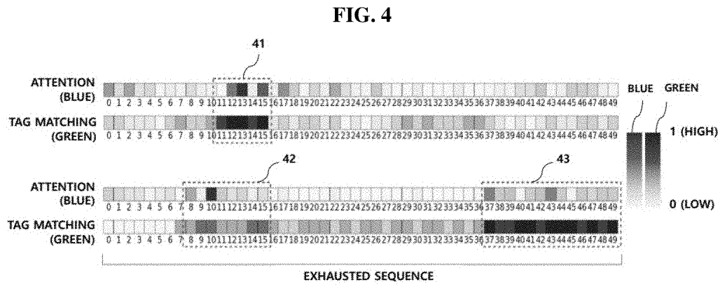

FIG. 4 is a diagram for describing correlation between weighted question information and a tag matching ratio according to an embodiment of the present invention. According to an embodiment of the present invention, question attention (weight) may be defined as a distribution of importance of question data solved by the user, which has influenced prediction of the correct answer probability for a question that the user did not solve.

Referring to FIG. 4, question information in which a high weight (attention) is assigned to prediction of a correct answer probability for a certain question is shown in dark blue, and question information with a high tag matching ratio with the certain question is shown in dark green.

Numbers 0 through 49 may represent the numbers of solved questions. However, according to an embodiment, each number may represent a tag included in one or more questions.

The weight and the tag matching ratio may have a value between 0 and 1, and the sum of all the weights and the sum of all the tag matching ratios each have a value of 1. A portion in which the weight and the tag matching ratio are reflected relatively higher than those of other questions is represented by dotted boundary lines 41, 42, and 43.

Referring to boundary line 41, questions nos. 11 to 15 may be questions that have been determined to have a large influence on a correct answer probability because high weights are reflected thereon. In this case, it can be seen that a tag matching ratio also has a high value.

Referring to boundary line 42, questions nos. 8 to 15 may be questions that have been determined to have a large influence on a correct answer probability because high weights are reflected thereon. Likewise in this case, it can be seen that the tag matching ratio also has a high value.

Referring to boundary line 43, questions nos. 37 to 49 may be questions that have been determined to have a large influence on a correct answer probability because high weights are reflected thereon. Likewise in this case, it can be seen that the tag matching ratio also has a high value.

Through these results, the learning content recommendation system 50 may select learning content that can maximize the user's potential learning efficiency and recommend it to a user by analyzing a relationship between a previously-answered question and a question that can be recommended, based on tag matching ratio or weight.

In addition, when a recommendation question that the user has not yet solved is determined through the tag matching ratio or weight described above, a question that the user has already solved is determined as a recommendation question among questions having high weights for the determined recommendation question such that the user can solve the question again, allowing the user to efficiently review the vulnerable type of questions.

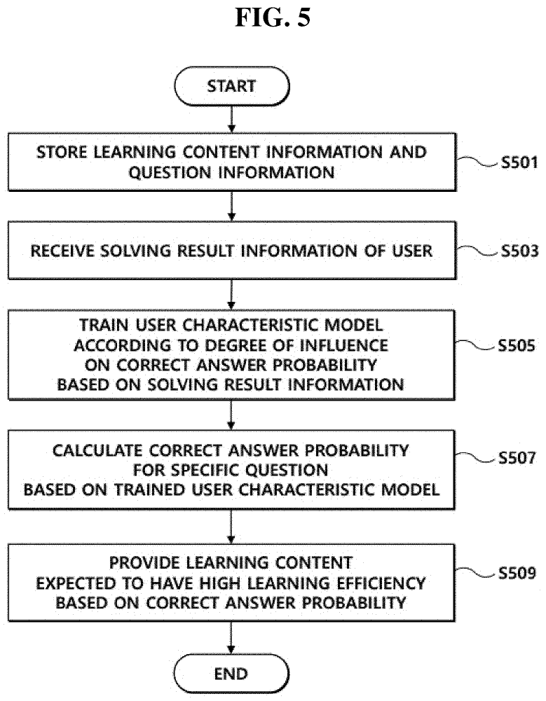

FIG. 5 is a flowchart for describing an operation of a learning content recommendation system 50 according to an embodiment of the present invention.

Referring to FIG. 5, in step S501, the learning content recommendation system 50 may store a plurality of learning content information and question information.

In step S503, the learning content recommendation system 50 may receive the user's solving result information. The solving result information may indicate whether the user has answered a relevant question correctly. Furthermore, the solving result information may indicate which answer the user has selected among a plurality of answers for multiple choice question. The answer selected by the user may be a correct answer or an incorrect answer. However, training the user characteristic model based on the information in both cases can more accurately reflect the user's ability.

The question information and solving result information corresponding thereto may be matched and stored, and then input to a user characteristic model and used for training of an artificial intelligence model.

In step S505, the learning content recommendation system 50 may train a user characteristic model according to a degree of influence on a correct answer probability based on the solving result information.

The training of the user characteristic model may be an operation of assigning weights to the question information according to a degree of influence on prediction of the correct answer probability.

For example, a type of questions which the user has often incorrectly answered may be an important type of question that reduces the user's total score. The question type is assigned a high weight, and it can be predicted that the correct answer probability of a user is low for a new question having a similar question type.

In an embodiment, a question type which the user hardly answers incorrectly may be another important type of question that increases the user's total score. According to embodiments, such a question may be assigned a high weight, and it may be predicted that the correct answer probability of the user is high for a new question having a similar question type.

In another embodiment, a high weight may be assigned to questions which have the same type but for which the user irregularly provides a correct answer. This is because the user may not have an established concept for the question type. In addition, weights may be assigned to solving result information according to various algorithms.

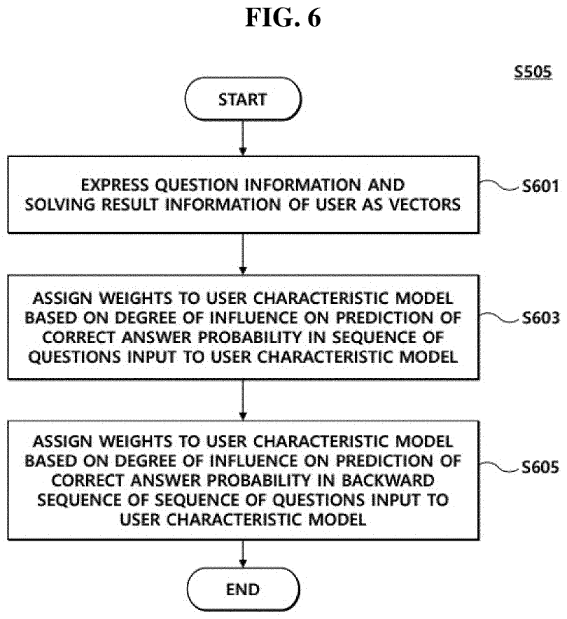

The step S505 of training of the user characteristic model will be described in detail in the description with reference to FIG. 6 to be described later.

In step S507, the learning content recommendation system 50 may calculate a correct answer probability for a specific question based on the trained user characteristic model.

The operation of calculating the correct answer probability may be performed based on a weight. When a question of which the correct answer probability is to be predicted is input, the correct answer probability may be calculated through an inference process in which various operations are performed by applying a weight to the corresponding question.

In step S509, the learning content recommendation system 50 may provide learning content that is expected to have high learning efficiency based on the correct answer probability.

For example, questions that are predicted to have a low correct answer probability, and lectures and explanatory materials explaining the core concepts of these questions can be provided to the user.

In addition, according to an embodiment, the learning content is not determined based on a correct answer probability calculated based on weights, but questions having a high tag matching ratio may be provided to the user.

FIG. 6 is a view for describing in detail step S505 of FIG. 5.

Referring to FIG. 6, in step S601, a learning content providing system 50 may express question information and user solving result information as a vector. The question information and solving result information expressed as vectors are embedded and expressed as numerical values, which can be input into an artificial intelligence model.

In step S603, the learning content providing system 50 may assign a weight to a user characteristic model based on a degree of influence on the prediction of the correct answer probability in the sequence of questions input to the user characteristic model.

For example, when the questions nos. 1 to 50 are sequentially input to the user characteristic model, the learning content providing system 50 may sequentially assign weights up to question no. 50 in the sequence of assigning a weight to question no. 1 first and then a weight to question no. 2.

In step S605, the learning content providing system 50 may assign a weight to a user characteristic model based on a degree of influence on the prediction of the correct answer probability in the backward sequence to the sequence of questions input to the user characteristic model.

In the above example, the learning content providing system 50 may sequentially assign weights up to question no. 1 in the sequence for assigning a weight to question no. 50 first and then a weight to question no. 49.

The sequence of questions input to the user characteristic model may be a sequence in which the user solves the questions. Whenever the user solves a question, solving result information of the question may be transferred to the user characteristic model in real time. Based on this, it is possible to predict in real time a correct answer probability of the next question to be provided to the user.

However, the sequence of the questions input to the user characteristic model may be the sequence in which the administrator inputs question information and solving result information, which are previously accumulated, in an arbitrary sequence in order to train artificial intelligence, and the sequence of questions input to the user characteristic model may be determined according to various algorithms.

According to the present invention, it is possible to predict a correct answer probability of a user for a specific question with higher accuracy using only limited question information and user response information through an artificial intelligence model with a bidirectional LSTM architecture in which weights are assigned to questions solved by a user and responses to the questions in forward sequences and backward sequences. Further, according to the present invention, it is possible to express question vectors such that the characteristics of questions are better reflected through the artificial intelligence model, making it easy to interpret the characteristics of the questions from the question vectors.

In addition, according to the present invention, there is an effect of providing learning content with increased efficiency by introducing the concept of weighting in the education domain, defining question weights as the distribution of importance of the question data solved by the user, which influenced the prediction of the correct answer probability for a question which the user did not solve, and recommending learning content based on a question that has a high influence on prediction of the correct answer probability, not the similarity of a question vector corresponding to a question which a user has frequently answered incorrectly.

Furthermore, the present invention can provide a method for interpreting a question vector abstracted and expressed through an artificial intelligence model with a bidirectional LSTM architecture, and solve a problem that it is difficult to dynamically update the user's state by defining the user's state only with question solving results resulted from solving of the question solved by the user, thus improving learning efficiency by introducing a method for recommending review questions using attention in the field of education where it is difficult and expensive to create new learning content.

The embodiments of the present invention disclosed in the present specification and drawings are provided only to provide specific examples to easily describe the technical contents of the present invention and to aid understanding of the present invention, and are not intended to limit the scope of the present invention. It is obvious to those of ordinary skill in the art that other modifications based on the technical idea of the invention can be implemented in addition to the embodiments disclosed therein.

What is claimed is:

1. A method for operating a learning content recommendation system, comprising:
transmitting question information including information on a plurality of questions to a user;
receiving solving result information that is the user's response for the plurality of questions; and
training a user characteristic model based on the question information and the solving result information,
wherein the training of the user characteristic model includes
assigning a weight to the user characteristic model based on a degree of influence on a correct answer probability in a sequence of questions input to the user characteristic model.

2. The method of claim 1, wherein the training of the user characteristic model includes
assigning a weight to the user characteristic model based on a degree of influence on a correct answer probability in a backward sequence of the sequence of questions input to the user characteristic model.

3. The method of claim 1, wherein the question information includes tag information on a subject matter of a question, a question type, a key word, and a text format.

4. The method of claim 1, further comprising:
calculating a correct answer probability for a specific question based on the user characteristic model; and
providing learning content that is expected to have higher learning efficiency than other learning content based on the calculated correct answer probability.

5. The method of claim 4, wherein the providing of the learning content includes
calculating a tag matching ratio with the specific question for each question based on a tag information included in each question; and
providing the specific question and a question of which the calculated tag matching ratio is greater than a preset value to a user.

6. The method of claim 1, wherein the assigning of the weight includes assigning the weight to question information corresponding to a question type for which the user frequently provides an incorrect answer.

7. The method of claim 1, wherein the sequence of questions input to the user characteristic model is a sequence in which a user solves a question.

8. A learning content recommendation system, comprising:
a learning information storage unit configured to store question information that is information about a plurality of questions, solving result information of a user's response for the plurality of questions, or learning content; and
a user characteristic model training unit configured to train a user characteristics model based on the question information and the solving result information,
wherein the user characteristic model training unit assigns a weight to the user characteristics model based on a degree of influence on a correct answer probability according to a sequence of questions input to the user characteristics model.
